(19) United States
(12) Patent Application Publication
(10) Pub. No.: US 2013/0206656 A1
(43) Pub. Date: Aug. 15, 2013

(54) APPARATUS FOR CARRYING OUT CHROMATOGRAPHY

(71) Applicants: Hans-Joachim Johl, Schwieberdingen (DE); Gary G. Gaudet, Sunrise, FL (US); Matthias Dörling, Grunbach (DE)

(72) Inventors: Hans-Joachim Johl, Schwieberdingen (DE); Gary G. Gaudet, Sunrise, FL (US); Matthias Dörling, Grunbach (DE)

(73) Assignee: LEWA GMBH, Leonberg (DE)

(21) Appl. No.: 13/817,164

(22) PCT Filed: Jul. 29, 2011
(86) PCT No.: PCT/EP2011/003896

§ 371 Date: Apr. 11, 2013

(30) Foreign Application Priority Data
Aug. 17, 2010 (DE) 10 2010 034 585.7

(51) Int. Cl. G01N 30/16

(52) U.S. Cl. CPC G01N 30/16
USPC 210/143

(57) ABSTRACT

Apparatus for carrying out chromatography, preferably liquid process chromatography, in particular for industrial applications, using in each case at least one positive displacement pump, provided with a drive, for feeding product and eluent (mobile phase) onto at least one separation column, wherein the drive of each positive displacement pump is a highly dynamic drive, which is equipped with an integrated transducer system for capturing the distance/time date, which are convertible into corresponding position-regulated travel commands using connected superordinate movement control/regulation.

### BACKGROUND OF THE INVENTION

1. Field of the Invention

The invention relates to an apparatus for carrying out chromatography, preferably liquid process chromatography, in particular for industrial applications, using in each case at least one positive displacement pump, provided with a drive, for feeding product and eluent (mobile phase) into a separation column (stationary phase).

2. Description of Related Art

As is known, chromatography represents a method which permits the separation of a mixture of substances through differential distribution of its individual components between a stationary and a mobile phase.

Different substances in the mobile phase are hereby transferred to a stationary phase. Due to the interactions between the sample, the stationary phase and the mobile phase, individual substances are transported at different speeds and thus separated from one another.

In order to perform chromatography it is necessary to establish the flow of the mobile phase, supply the sample which is to be separated and carry out the actual separation and the subsequent detection. The mobile phase is usually induced to flow by means of pressure which is generated through a positive displacement pump.

In addition to its use in analytical laboratories, chromatography has become established in industrial processes as a method for the separation and purification of useful substances. Whereas a whole series of suitable pump solutions exists for supplying the separation columns with the necessary media in laboratory applications, the choice of pump solutions available for the industrial process is significantly more limited. Here too, in part due to the requirement for sterility, for example in the case of biotechnological or biopharmaceutical products, the pump systems which are used must, on the one hand, be hermetically sealed and must function very precisely, since they need at any time to transport a reproducible quantity of products and eluents against a counterpressure which varies according to the loading condition of the column. On the other hand, increasingly large throughput quantities of the order of several cubic meters per hour require particular care with regard to integration in the overall system in terms of fluid dynamics.

A tendency has been observed involving a move away from discontinuous buffer preparation towards continuous manufacture, for example, Simulated Moving Bed technology (SMB). The reason for this lies in the continually increasing quantities consumed and the variety of media and concentrations of eluents and buffer solutions involved, which quickly lead to an uneconomical amount in the case of a conventional batch process. Consequently, continuous operation is significantly more efficient.

However, this mode of operation gives rise to new, different problems. In addition to the more volume- and cost-intensive storage requirements for the various media and the necessity of forward-thinking planning management, with continuous chromatography the security of a full analysis as well as the possibility of subsequent correction is lost. Accordingly, the pumps, valves, mixing apparatus and measuring equipment necessary for producing the mobile phase in a continuous process must be particularly reliable, precise, and also reliably sterile over a long period of time.

### SUMMARY OF THE INVENTION

Bearing in mind the problems and deficiencies of the prior art, it is therefore an object of the present invention to provide an apparatus of the generic kind such that it represents a complete functional module, including all process-relevant fittings, for integration in chromatography plants, and displays or guarantees an exact, reproducible metering accuracy, wide adjustment ranges and a high product quality.

The above and other objects, which will be apparent to those skilled in the art, are achieved in the present invention which is directed to an apparatus for carrying out chromatography for industrial applications, comprising at least one positive displacement pump, provided with a drive, for feeding product and mobile phase eluent into at least one separation column, the drive of each positive displacement pump being a dynamic drive in the form of a permanent-field, fanless, three-phase synchronous servomotor which drives the positive displacement pump, wherein the three-phase synchronous servomotor is equipped with an integrated transducer system for capturing the distance/time data, convertible into corresponding position-controlled travel commands using a connected superordinate movement control/regulation.

The apparatus includes two pumps, each with a dynamic drive with an associated movement control/regulation, such that the pumps are operable in an optimal relationship to one another through electric synchronization and variable angular speed.

The positive displacement pumps make possible a low-pulsation, even distribution when feeding media to distributor bases through metered flow curves adjustable to a relevant separation process, protecting a stationary phase and providing improved separation conditions with respect to chromatogram quality, in the separation column, and adjustable fluid kinematics of a mobile phase, through use of the positive displacement pumps and their precise movement control/regulation by corresponding position-controlled travel commands. The positive displacement pumps and their drives are designed as a fully-automated total system. The adjustable fluid kinematics may include isocratic, stepwise, or gradient elution of the mobile phase.

The chromatography may include liquid process chromatography.

The drive of each positive displacement pump may be designed to be clean-room-compatible.

The positive displacement pump may include a diaphragm metering pump.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 shows in diagrammatic form the structure of an invented apparatus for carrying out liquid process chromatography;

FIG. 2 shows a modified embodiment thereof; and

FIG. 3 shows a curve diagram in which the volumetric flows of the suction and discharge stroke of the pump are shown over time.

### DESCRIPTION OF THE PREFERRED EMBODIMENT(S)

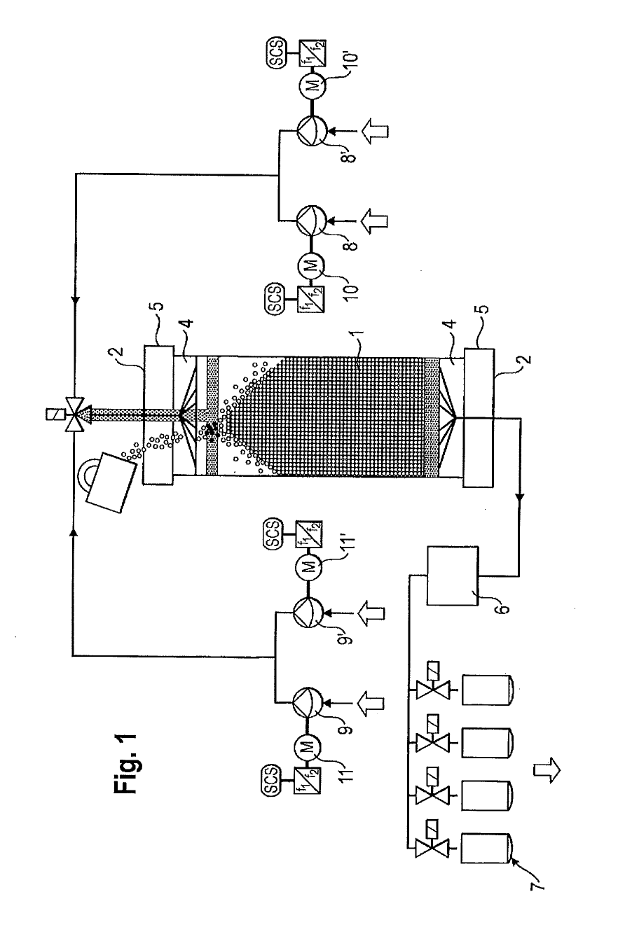

In describing the preferred embodiment of the present invention, reference will be made herein to FIGS. 1-3 of the drawings in which like numerals refer to like features of the invention.

The invention is based on the problem of designing the apparatus of the generic kind such that an improvement in the separation of individual partial quantities as well as an increase in the accuracy of the separating process is achieved.

The preferred embodiment is based on the remarkably simple but very effective idea of using as the drive for each positive displacement pump which serves to feed product and eluent (mobile phase) into at least one separation column (stationary phase) a highly dynamic drive which is equipped with an integrated transducer system for capturing the current distance/time data, which are converted into corresponding position-controlled travel commands by means of a connected intelligent movement control/regulation. Only in this way is it possible to drive the positive displacement pump in such a manner that the otherwise typical pressure and volume pulsation can be noticeably reduced.

Using this drive system, in combination with positive displacement pumps, very precise volumetric flows can be achieved in different operating modes which can, in addition, also be adjusted to the plant-specific circumstances, such as the installation of valves, through special movement controls of the positive displacement pumps.

In a further embodiment of the invention, the drive system of each positive displacement pump consists of a servomotor, preferably a permanent-field three-phase synchronous servomotor, and an associated drive intelligence with corresponding movement control/regulation which is stored in the drive in the form of a program code.

An oscillating positive displacement pump, in particular a diaphragm pump, preferably a diaphragm metering pump, and/or a rotary positive displacement pump can be used as a positive displacement pump.

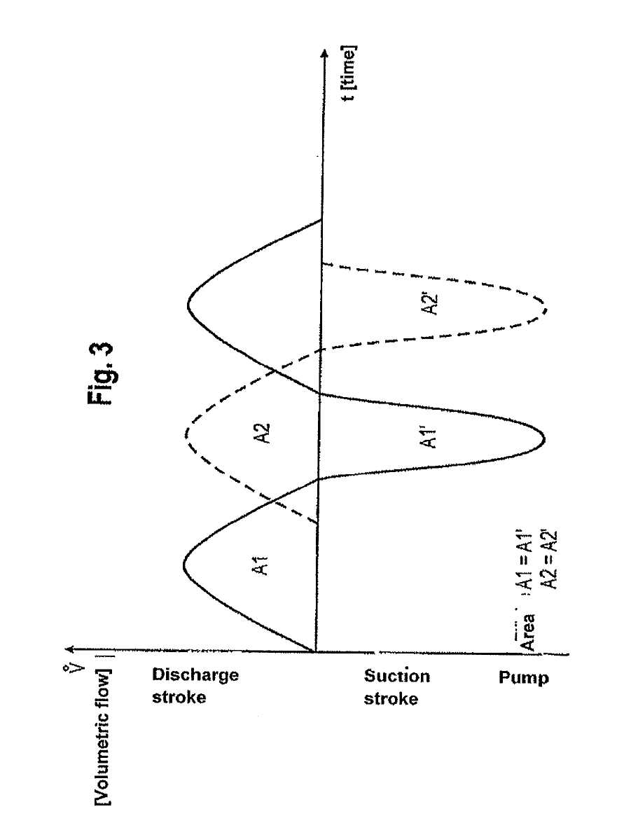

Particular advantages result if the invented apparatus consists of two diaphragm metering pumps and the aforementioned drive system and an associated movement control/regulation is designed such that the diaphragm metering pumps are operated in an optimal relationship to one another through electric synchronization and variable angular speed. This optimal relationship can represent the relationship in time between the volumetric flow strokes of the individual pumps, as can readily be seen from the curve diagram shown in FIG. 3.

Through this form of movement control, a resulting volumetric flow can be generated which, for example, reduces the pulsation of the volumetric flow and pressure, thus leading to considerable advantages, for example in connection with the feeding of the chromatography columns.

A significant improvement in the accuracy of the separating method is thus achieved through the invented apparatus, at the same time achieving an expanded dynamic adjustment range and guaranteed low level of pulsation.

Due to the exact, reproducible metering accuracy, the wide adjustment ranges and the high product quality, an apparatus equipped in accordance with the invention can, among others, be used in the following processes:

(a) industrial low- and medium-pressure chromatography in the range from 1 l/h to over 5000 l/h against 20 bar;

(b) high-pressure chromatography in the range from 1 l/h to over 5000 l/h against 350 bar and higher; and

(c) continuous methods.

Numerous advantages can be achieved with the invented apparatus. For example, the combination “variation of the rotational speed” and “partial stroke mode” makes possible an adjustment range of up to over 1:100. Whereas, in order to achieve this, conventional technology requires a frequency converter and possibly also an electric stroke adjustment, which are fed via separate power and data connections, the invented apparatus only requires a single connection for this purpose. Also, any desired gradient for the transport of the eluent (mobile phase) can be adjusted, with high precision, this being possible in both industrial low-pressure chromatography and in high-pressure chromatography. Finally, the intelligent control of two pumps makes virtually pulsation-free delivery possible.

Furthermore, the following further advantages can be achieved with the invented apparatus:

a flow of the sample through the separation column with minimal pulsation;

where a biomass needs to be examined which is, by its nature, highly sensitive, a low-shear process is possible, especially where diaphragm metering pumps are used;

if desired, a constant volumetric flow can be achieved, both with isocratic elution (constant concentration) as well as with stepwise or gradient elution, irrespective of the counterpressure;

only a low dead volume (“hold-up”) is present up to the separation column, which makes it possible to achieve a better gradient, i.e., a better peak. This does not lead to any back-mixing, because all the parts can be built smaller; this means that overall a smaller overall volume of fluid is present in the plant, which, due to the pressure-resistant pump line, makes possible the use of smaller pipe cross sections and components and avoids the use of otherwise necessary pulsation dampers;

an adjustment range of the pump of up to 1:150 and higher is possible, allowing higher buffer concentrations to be achieved;

due to the programmed control, a fully automated process is possible, allowing operating errors, for example due to the previously necessary manual adjustment of the stroke, to be ruled out;

the fully automatic process allows perfect documentation to be created; and

overall, a better yield is achieved, which is a particular advantage in view of the already high costs of the substances which are to be separated.

As can be seen from FIG. 1, the shown apparatus is provided with a vertically arranged separation column 1 which is provided at its upper end with a cover 2 and a distributor/collector 4 and possesses a collector/distributor 4 and a base 5 at its lower/upper end.

As can also be seen, the collector 4 is connected with a detector 6 which serves to detect the separated substances and is connected with a fraction collector 7 which in turn serves to collect the separated substances.

In the embodiment shown, the separation column 1 possesses two diaphragm pumps 8, 8′ for the product feed and/or eluent feed and two diaphragm pumps 9, 9′ for the feed of the eluent (mobile phase), wherein these pumps 8, 8′, 9, 9′ are connected to the upper end of the separation column 1 via a common feed pipe for feeding the relevant product. For other separating tasks, it is advantageous to connect these pumps 8, 8′, 9, 9′ via a common feed pipe to the lower end of the separation column 1.

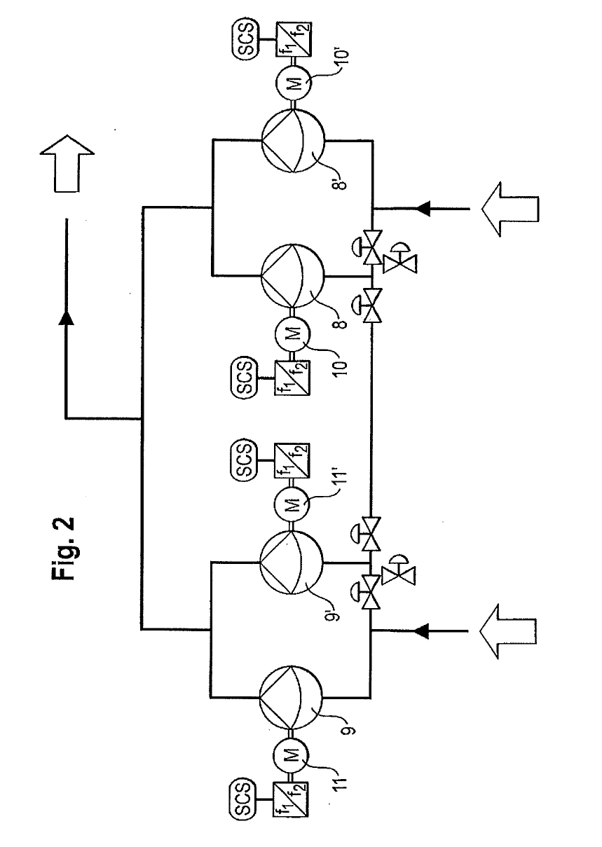

The pump arrangement shown in FIG. 2 is an expansion of the previously-shown embodiment with separate feed to the pumps 8, 8′ and 9, 9′. On the suction side, the fluid pipes are connected via a combination of valves shown on the suction side of the pumps and on the discharge side of the pump are passed out to the separation column via a common connected pipe. This connection makes it possible to connect the pumps 8 and 9′ individually to both fluid infeeds. The advantage lies in the expansion of the bandwidth of the possible throughflow rates. Differentiated operating modes are possible depending on the switch settings of the valves on the suction side of the pumps 8 and 9′ and permit combined volumetric flows of the pumps 8, 8′, 9, 9′.

Each diaphragm pump 8, 8′, 9, 9′ is equipped with a highly dynamic drive 10 or 10′, 11, 11′ which in each case possesses an integrated programmable control for achievement of the desired technical properties, for example monotonically increasing or gradient elution. It is of particular importance here that each drive 10, 10′, 11, or 11′ is a permanent-field three-phase synchronous servomotor which, due to its design, permits the desired property to be achieved when carrying out the chromatography.

FIG. 3 shows a curve diagram in which the volumetric flows of the suction and discharge stroke of the pump are shown over the time t. As mentioned, it can be seen from this curve diagram that the optimal relationship for two diaphragm metering pumps can represent the relationship in time between the volumetric flow strokes of the individual pumps.

With regard to features not explained in detail above, reference is otherwise expressly made to the drawings and claims.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. Apparatus for carrying out chromatography for industrial applications, comprising at least one positive displacement pump, provided with a drive, for feeding product and mobile phase eluent into at least one separation column,
the drive of each positive displacement pump being a dynamic drive in the form of a permanent-field, fanless, three-phase synchronous servomotor which drives the positive displacement pump, wherein the three-phase synchronous servomotor is equipped with an integrated transducer system for capturing the distance/time data, convertible into corresponding position-controlled travel commands using a connected superordinate movement control/regulation.

2. The apparatus of claim 1 including two pumps, each with a dynamic drive with an associated movement control/regulation, such that the pumps are operable in an optimal relationship to one another through electric synchronization and variable angular speed.

3. The apparatus of claim 1 wherein the positive displacement pumps make possible a low-pulsation, even distribution when feeding media to distributor bases through metered flow curves adjustable to a relevant separation process, protecting a stationary phase and providing improved separation conditions with respect to chromatogram quality, in the separation column, and adjustable fluid kinematics of a mobile phase, through use of the positive displacement pumps and their precise movement control/regulation by corresponding position-controlled travel commands.

4. The apparatus of claim 1 wherein the positive displacement pumps and their drives are designed as a fully-automated total system.

5. The apparatus of claim 2 wherein the positive displacement pumps make possible a low-pulsation, even distribution when feeding media to distributor bases through metered flow curves adjustable to a relevant separation process, protecting a stationary phase and providing improved separation conditions with respect to chromatogram quality, in the separation column, and adjustable fluid kinematics of a mobile phase, through use of the positive displacement pumps and their precise movement control/regulation by corresponding position-controlled travel commands.

6. The apparatus of claim 1 wherein said chromatography includes liquid process chromatography.

7. The apparatus of claim 1 wherein the drive of each positive displacement pump is clean-room-compatible.

8. The apparatus of claim 1 wherein the positive displacement pump comprises a diaphragm metering pump.

9. The apparatus of claim 3 wherein said adjustable fluid kinematics includes isocratic, stepwise or gradient elution of the mobile phase.
